(19) United States
(12) Patent Application Publication
(10) Pub. No.: US 2019/0220886 A1
(43) Pub. Date: Jul. 18, 2019

(54) NEGOTIABLE DIGITAL DURABLE COUPON TOKEN

(71) Applicants: Minh-Michael Van Le, Morgan Hill, CA (US); Michael Han, Morgan Hill, CA (US)

(72) Inventors: Minh-Michael Van Le, Morgan Hill, CA (US); Michael Han, Morgan Hill, CA (US)

(21) Appl. No.: 15/870,042

(22) Filed: Jan. 12, 2018

(51) Int. Cl. G06Q 30/02

(52) U.S. Cl. CPC G06Q 30/0239; G06Q 20/0658

(57) ABSTRACT

A computerized process can be used to create and distribute a durable coupon token redeemable with a company agreeing to permit a user redeem the durable coupon token for a discount. The process includes, within a computerized processor, operating programming configured to create the durable coupon token. The durable coupon token includes a digital security key associated with the durable coupon token configured to provide transferrable ownership of the durable coupon token. The process further includes distributing the durable coupon token to a consumer. The durable coupon token is configured to enable the consumer to claim the discount with the company.

### TECHNICAL FIELD

This disclosure is related to a computerized process for issuing and trading digital coupon tokens.

### BACKGROUND

The statements in this section merely provide background information related to the present disclosure. Accordingly, such statements are not intended to constitute an admission of prior art.

Digital currencies such as Bitcoin are known in the art. Bitcoins exist as decentralized currency traded through transfer of secure keys between a selling party and a buying party. A Bitcoin is worth whatever value one is willing to accept the Bitcoin for as payment. One vendor may advertise three nights stay at a hotel for one Bitcoin. Another vendor may agree to accept two Bitcoins in forgiveness of $1,000 in debt. An investor may go online to a Bitcoin market website such as Coinbase® or Blockchain® and view offers to sell Bitcoins for a current market price.

Digital coupons are known in the art. Issued by vendors such as Groupon®, a company selling a good or service contracts with the coupon vendor to get coupons advertised and issued to consumers. For a fee, the consumer gets a coupon that can be posted in an email to the consumer, and the consumer can tender the coupon with the company selling the good or service for the advertised discount.

### SUMMARY

A computerized process can be used to create and distribute a durable coupon token redeemable with a company agreeing to permit a user redeem the durable coupon token for a discount. The process includes, within a computerized processor, operating programming configured to create the durable coupon token. The durable coupon token includes a digital security key associated with the durable coupon token configured to provide transferrable ownership of the durable coupon token. The process further includes distributing the durable coupon token to a consumer. The durable coupon token is configured to enable the consumer to claim the discount with the company.

### BRIEF DESCRIPTION OF THE DRAWINGS

One or more embodiments will now be described, by way of example, with reference to the accompanying drawings, in which:

FIG. 1 illustrates an exemplary computerized process for creating, trading, and redeeming a durable coupon token generic to a group of participating companies honoring the durable coupon token, in accordance with the present disclosure;

FIG. 2 illustrates an exemplary process flowchart for creating, distributing, trading, and redeeming durable coupon tokens generic to a group of participating companies, in accordance with the present disclosure;

FIG. 3 illustrates a computerized process for creating, trading, and redeeming a durable coupon token, in accordance with the present disclosure;

FIG. 4 illustrates the marketplace of FIG. 3 in greater detail, in accordance with the present disclosure;

FIG. 5 illustrates an exemplary server device configured to operate a durable coupon token creation and distribution process, in accordance with the present disclosure; and

FIG. 6 illustrates an exemplary process for creating, distributing, trading, and redeeming durable coupon tokens, in accordance with the present disclosure.

### DETAILED DESCRIPTION

A process for creating and trading a digital coupon or digital coupon token is provided. Such a digital coupon token can be durable, such that when a consumer or company redeems the coupon with a company honoring the coupon, the coupon survives and can be used in subsequent transactions. Such a durable coupon token can be used to facilitate transactions, provide targeted discounts, increase traffic in a business, and other known benefits common to advertising. The durable coupon token is negotiable, meaning that the owner of it may use, trade, or otherwise transfer the ownership it with others at will.

A first embodiment of the discloses process is provided. A coupon vendor company can create a generic durable coupon and introduce the durable coupon in a marketplace of consumers and companies that honor the coupon. That durable coupon can be redeemed at a first company, and the first company can either then redeem the coupon at a second company honoring the coupon or reintroduce the coupon to the marketplace. This reoccurring process benefits both the consumers and the companies honoring the coupons.

A coupon vendor can create a single type or class of generic coupons. These coupons can be good at any participating company honoring the coupons. A coupon can be used for 50 cents off of a cup of coffee and then the same day be used for $500 off of a car purchase. In another embodiment, a coupon vendor can make classes of generic coupons, with a first class of coupons being redeemable for consumer goods such as toothpaste and soft drinks, and with a second class of coupons being redeemable for a ton of steel or a month's rental of a bulldozer. In another embodiment, a coupon vendor can make a company specific coupon, for example, with Walmart® commissioning and distributing ten thousand coupons for $5 off a next purchase.

Coupon vendors can make money by advertising the companies honoring the coupons on a website. Coupon vendors can make money by advertising to potential companies that might honor the coupons, increasing coupon circulation based upon fees charged to companies. Coupon vendors can make money creating special classes or types of coupons.

A second embodiment of the disclosed process is provided. A coupon vendor creates a digital coupon token and sells it to consumers on behalf of a company providing a good or service. The company selling the good or service can be referred to as the coupon redemption company. The coupon token is durable and negotiable.

In a first example, the consumer can redeem or execute the token with the redemption company. If the coupon offers a $50 price reduction with the redemption company, the consumer can go to a retail location for the redemption company and purchase the advertised good or service at a $50 price reduction. The durable nature of the coupon is then invalidated and the redeemed coupon is then destroyed or devalued.

In another example, a second company selling a good or a service can decide to accept the durable coupon token as full or partial payment. For example, Company ABC can advertise a $30 value for Company ABC's product in exchange for transfer of the $50 coupon with the redemption company to Company ABC.

A number of motivations can exist for Company ABC to trade value for the durable coupon token for the redemption company. For example, Company ABC may use or resell products from the redemption company, and in buying $50 coupons for $30, Company ABC gets a $20 value for products purchased from the redemption company. In another example, the redemption company may seek to reduce the value of coupon redemptions by offering bulk redemption credits or cash value, for example, offering $40 cash each for a redemption of one hundred coupon tokens. Company ABC may trade for and stockpile the $50 face value coupons and redeem the coupons for $4,000 cash from the redemption company once one hundred are stockpiled. In another example, Company ABC can trade for coupon tokens and provide access to the coupon tokens to Company ABC's customers as a benefit for being customers. In another example, Company ABC can acquire durable coupon tokens for the redemption company based upon a speculated value of the coupons. For example, if the coupons offer a conditional value such as “Get an extra 10% off the purchase price when the home team wins the world series,” Company ABC can trade for the durable coupon tokens based upon speculation that the conditional event will occur. In another example, the durable coupon token can provide access to a limited product, such as access to a new highly demanded cellular phone on the day of release or access to a concert or cultural or sporting event on a particular day. Company ABC can trade for the coupons providing access to the limited release product based upon speculation of resale value of those coupons to consumers or later trading value of the coupons to speculators.

Durable coupon tokens can be marketed and traded for in a number of different ways. For example, in a system similar to the distributed trading system utilized to trade Bitcoins, a system of security keys and digital wallets can be used to distribute and execute digital transfers of durable coupon tokens. For example, the redemption company can pay the coupon vendor a fee to create and market a thousand digital coupons with a selected face value for the coupons valid for redemption at the redemption company. The coupon vendor can advertise and execute transfers for each of the thousand coupons until they are gone. The coupons can be free to consumers but are frequently sold for a price to consumers. In some instances, some or all of the funds paid by consumers for the coupons can go back to the redemption company. In other instances, all of the funds paid by the consumers can be kept by the coupon vendor. The coupons can be marketed to consumers in any number of known ways, such as but not limited to email lists, advertisements on coupon offering websites, or through physical mailing advertisements. Such marketing can include directions for how to pay for and acquire access to the digital security key for the durable coupon token being sold. In other embodiments, the coupons can be made directly available upon coupon trading marketplaces.

In another example, instead of utilizing a distributed trading system, the durable coupon tokens can be sold and managed directly by the coupon vendor. In another example, instead of utilizing a distributed trading system, the durable coupon tokens can be sold by the coupon vendor and managed directly by the redemption company. In another example, an actual physical token representing the coupon can be produced, and the physical token can be utilized to initiate online processes to execute a trade, for example, with a cellular phone scanning a QR code printed upon the physical token initiating a trade subroutine on a remote server device managing and recording ownership of the coupon token.

Trading of durable coupon tokens can be performed within marketplaces at market prices. Durable coupon tokens can be traded as commodities. Redemption companies can repurchase their own coupon tokens if the prices become favorable.

Ownership of durable coupon tokens can be private information. In a system similar to the system utilized by Bitcoin, a user can set up an anonymous wallet, and ownership of the security key for a particular durable coupon token can be held within the wallet.

The coupon vendor can operate a website or other similar publication for the purposes of providing information to consumers about companies that are participating companies, agreeing to permit users to redeem coupons for value. Such a website can list companies agreeing to accept a generic coupon. Such a website can list companies agreeing to provide value in trade for a coupon with a particular redeeming company.

Throughout the disclosure, reference to coupons, coupon tokens, durable coupon tokens are meant to be interchangeable terms.

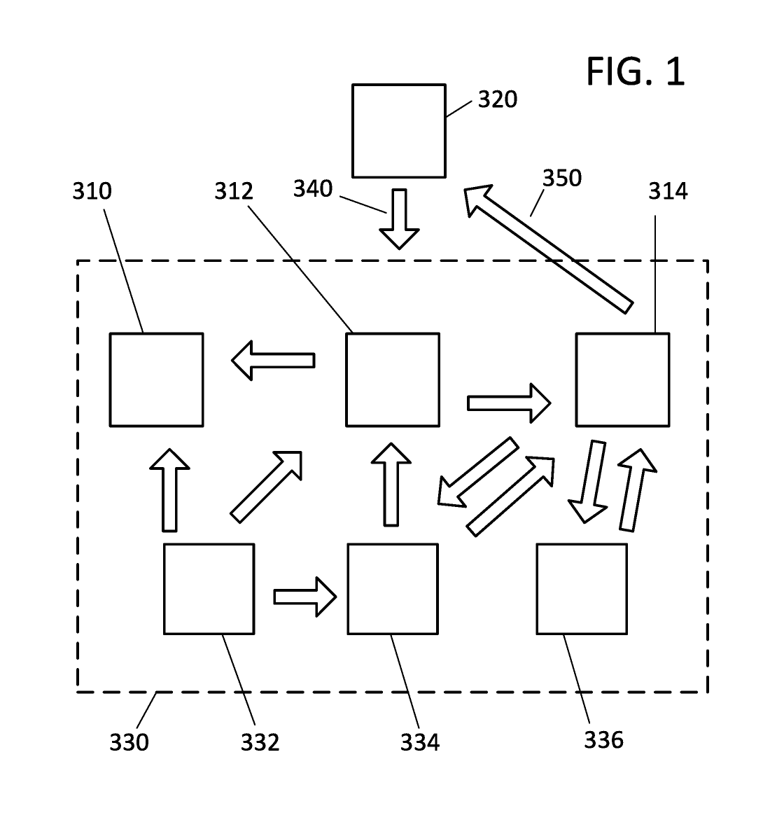

Referring now to the drawings, wherein the showings are for the purpose of illustrating certain exemplary embodiments only and not for the purpose of limiting the same, FIG. 1 illustrates an exemplary computerized process for creating, trading, and redeeming a durable coupon token generic to a group of participating companies honoring the durable coupon token. Coupon vendor 320 is illustrated, utilizing a distribution process 340 to provide durable coupon tokens to a marketplace 330. Marketplace 330 includes exemplary participating companies 310, 312, and 314, each agreeing to honor the durable coupon tokens. Marketplace 330 further includes exemplary consumers 332, 334, and 336, each receiving and redeeming coupons with the participating companies.

Distribution process 340 can include a number of different processes. For example, coupon vendor 320 can sell coupons upon a website. Coupon vendor 320 can provide a free coupon to first time visitors to a website or can sell memberships to a club where a coupon is provided every week for a yearly membership fee. Coupon vendor 320 can provide tokens to participating companies 310, 312, and 314 which can distribute them to potential or privileged customers. Tokens can be distributed through mailers, for example, with a QR code on a printed advertisement providing one free coupon to a consumer when scanned with a smart phone. Tokens can be put up for sale on third party digital market websites.

A number of exemplary transactions between consumers 332, 334, and 336 and participating companies 310, 312, and 314 are illustrated. Consumer 332 is illustrated redeeming coupons with participating companies 310 and 312 for value and either selling or giving a coupon to consumer 334. Consumer 334 is illustrated receiving a coupon from consumer 332, receiving a coupon from company 314, and redeeming coupons with participating companies 312 and 314. Consumer 336 is illustrated receiving and then redeeming a coupon with company 314. Company 310 receives coupons from both consumer 332 and company 312. Company 312 receives coupons from consumers and redeems the coupons for goods or services from both companies 310 and 314. Company 314 receives coupons from consumers 334 and 336 and company 314. Company 314 distributes coupons to consumers 334 and 336. Company 314 further provides or sells coupons back to coupon vendor 320. In some instances, coupon vendor 320 may provide a redemption value to participating companies, for example, to redistribute the coupons through the company's website. In some other instances, participating companies may decide that they benefit from the circulation of the coupons but also that they are not in the business of distributing coupons. Marketplace 330 and the transactions illustrated are exemplary, and the disclosure is not intended to be limited to the particular examples provided herein.

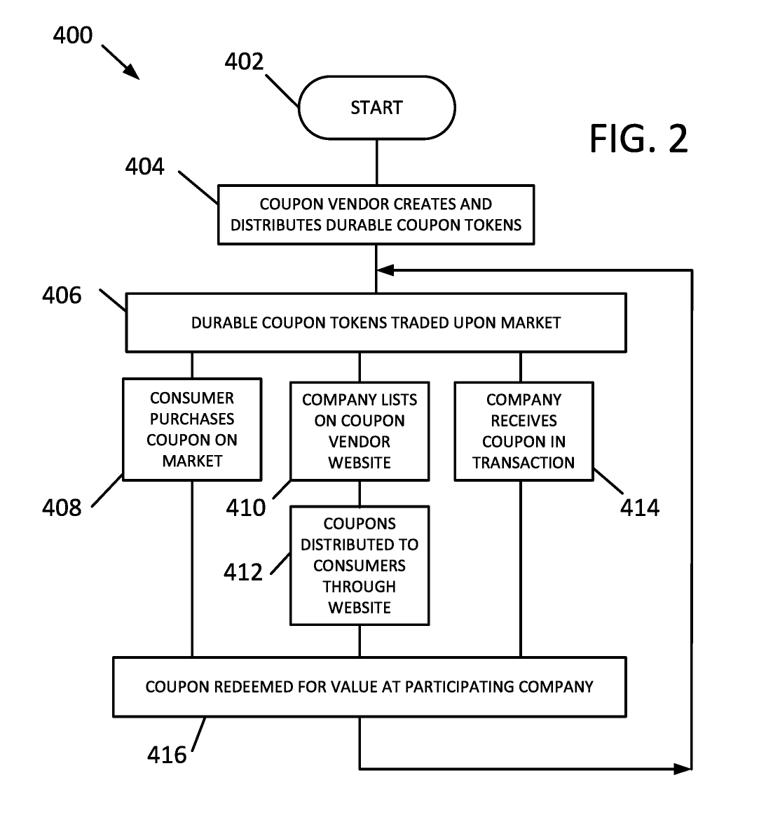

FIG. 2 illustrates an exemplary process flowchart for creating, distributing, trading, and redeeming durable coupon tokens generic to a group of participating companies. Process 400 starts at step 402. At step 404, the coupon vendor creates and distributes durable coupon tokens which a number of participating companies have agreed to honor, providing value in return for tendering a coupon. At step 406, the coupons are introduced to and traded upon the marketplace. At step 408, an exemplary consumer purchases a coupon upon the marketplace. This can be from an exemplary third party market website or from an advertising website set up by the coupon vendor. At step 416, the consumer redeems the coupon for value at a participating company. At step 410, a company, for example, a company not previously honoring the coupons, contacts the coupon vendor and lists the company on the coupon vendor's website as a participating company. At step 412, coupons are distributed to consumers through the website, for example, as a promotion run by the new company of step 410. At step 416, the consumers redeem the coupons for value at a participating company. At step 414, a company receives a coupon, for example, by a consumer redeeming the coupon with the company, and subsequently redeems the coupon with a different participating company for value at step 416. After being redeemed for value at step 416, the durable coupon tokens can return to the marketplace at step 406 to be reused over and over again.

A number of alternatives to process 400 are envisioned. The process steps of process 400 are provided as examples, and the disclosure is not intended to be limited to the particular examples provided.

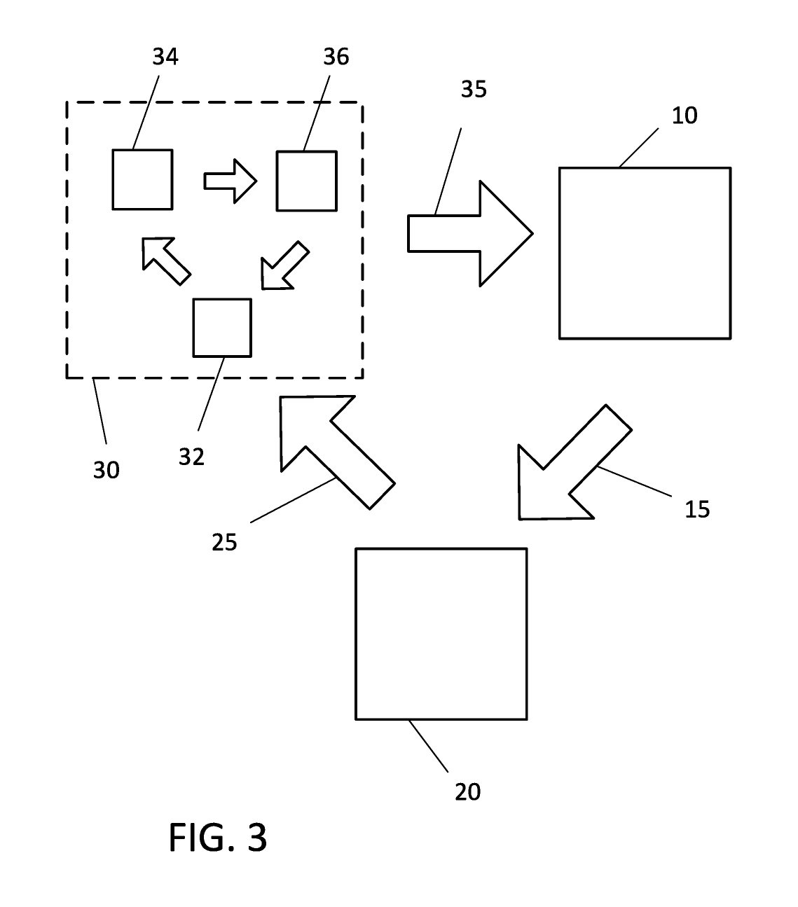

As an alternative to generic durable coupon tokens, another embodiment can include creating and distributing a durable coupon token including a particular redemption company and face value. FIG. 3 illustrates an exemplary computerized process for creating, trading, and redeeming a durable coupon token including a particular redemption company and face value. Redemption company 10, coupon vendor 20, and trading marketplace 30 are illustrated. Process transactions are further illustrated, including coupon campaign instructions 15, coupon creation and distribution process 25, and coupon redemption process 35 with the redemption company 10. Redemption company 10, for example, desiring to increase business and public awareness of a service provided by redemption company 10, provides coupon campaign instructions 15 to coupon vendor 20. Coupon vendor 20 creates secure digital keys for each of the coupons to be created and employs marketing processes known in the art to advertise, sell, and electronically distribute the secure digital keys associated with the durable coupon tokens through coupon creation and distribution process 25. Once distributed, durable coupon tokens can be freely traded in marketplace 30. At any point while the durable coupon tokens are in the marketplace (and the conditions inherent to the coupon, such as start and stop dates for the coupon, are met), an owner of a coupon token can initiate redemption process 35 with redemption company 10.

Marketplace 30 can include any number or types of potential owners for the coupon tokens. Exemplary potential owners are illustrated including consumer 32, second company 34, and speculator 36. Any of consumer 32, second company 34, and speculator 36 can acquire durable coupon tokens, sell durable coupon tokens, and redeem durable coupon tokens.

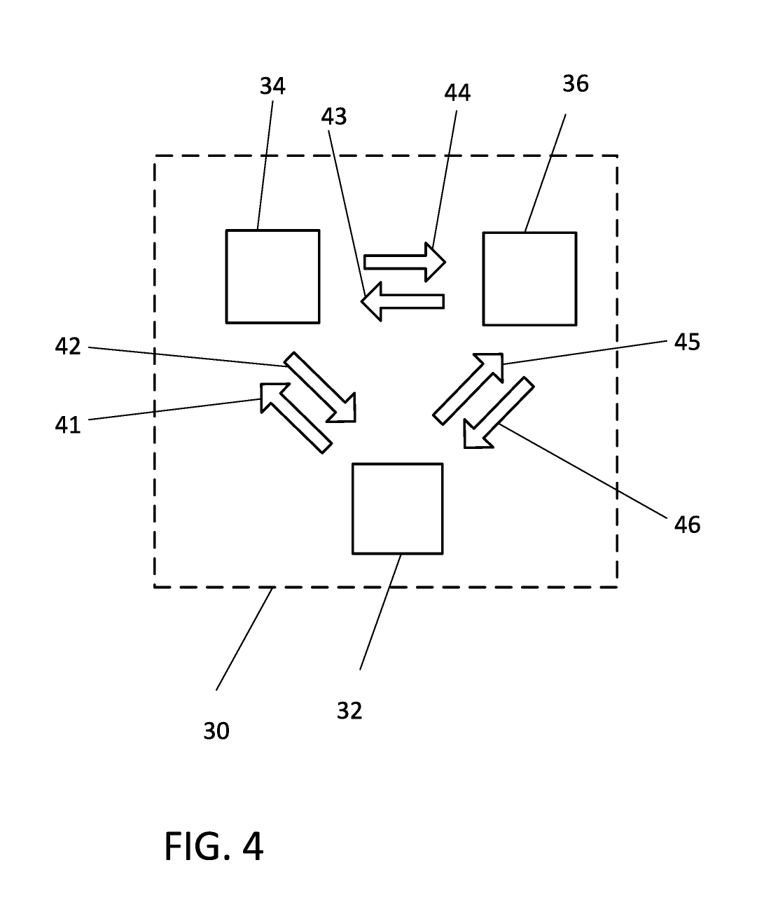

FIG. 4 illustrates the marketplace of FIG. 3 in greater detail. Marketplace 30 is illustrated including exemplary potential owners of durable coupon tokens including consumer 32, second company 34, and speculator 36. Exemplary transaction pairs are illustrated, included shaded arrows illustrating secure transfers of the digital security keys associated with ownership of the durable coupon tokens. In a first transaction pair, consumer 32 transfers ownership of a durable coupon token with second company 34 through secure transaction 41, and, in exchange, second company 34 provides an exemplary reduced price to consumer 32 through benefit transaction 42. In a second transaction pair, second company 34 transfers ownership of a durable coupon token with speculator 36 through secure transaction 44, and, in exchange, speculator 36 provides traded commodities to second company 34 through transaction 43. In a third transaction pair, speculator 36 transfers ownership of a durable coupon token with consumer 32 through secure transaction 46, and, in exchange, consumer 32 pays funds to speculator 36 through payment transaction 45. The exemplary transaction pairs are provided as examples, transactions can occur between any two parties, and the disclosure is not intended to be limited to the examples provided herein.

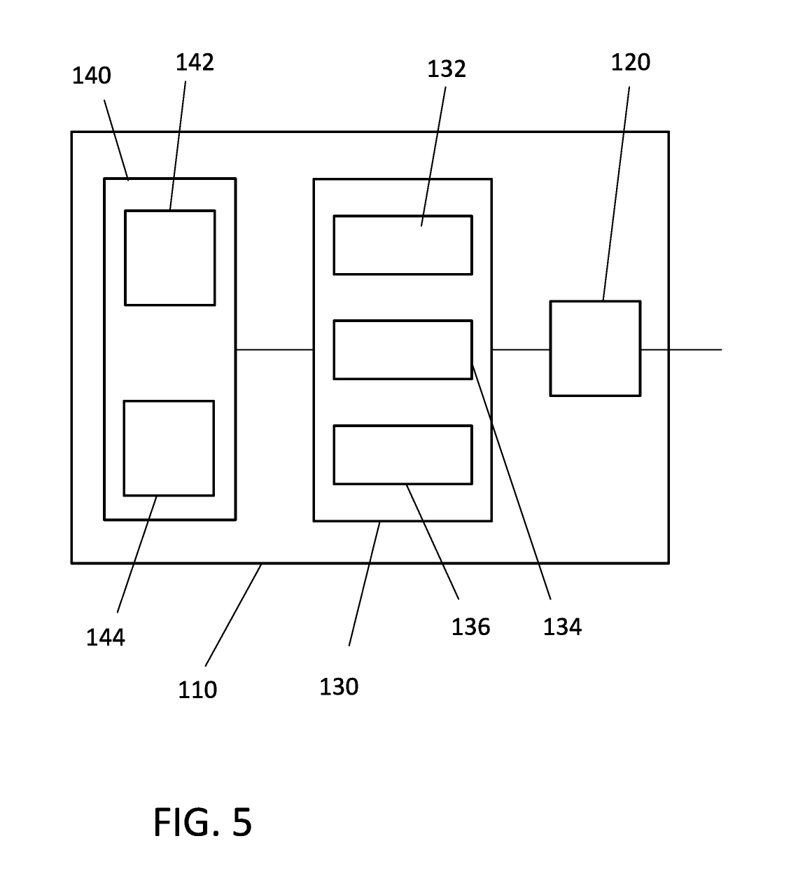

FIG. 5 illustrates an exemplary server device configured to operate a durable coupon token creation and distribution process. Server 110 is illustrated including a communications device 120, a processor device 130, and a storage device 140. Server device 110 is exemplary and can include any alternative computerized device capable of operating an online service or website. Server device 110 includes at least one computerized processor configured to operate processes as computerized code, random access memory, and memory configured to store data. Server device 110 can include a single physical device or can be embodied as a plurality of devices providing the combined functionality.

Communications device 120 includes a device configured to send and receive information over a communications network. Communications device 120 is configured to provide communicative connections between server 110 and a plurality of users simultaneously making use of the processes provided by server 110.

Processor device 130 includes a computerized processor and operates computerized processes embodied as one or more computerized modules 132, 134, and 136 including code configured to perform certain functions enabling the disclosed process. Exemplary modules illustrated include durable coupon token creation module 132, durable coupon token marketing module 134, and secure transaction initiation module 136.

Durable coupon token creation module 132 includes programming configured to create and provide information necessary for the transfer and identification of a plurality of durable coupon tokens and associated digital security keys for a durable coupon token campaign. Durable coupon token marketing module 134 includes programming configured to create exemplary emails, text messages, advertising banners, physical mailings, or other media mechanisms to advertise and publish availability of created durable coupon tokens. Durable coupon token marketing module 134 can further include programming configured to receive and process purchase orders for the durable coupon tokens. Durable coupon token marketing module 134 can further operate a website or other similar publication providing information to consumers about which companies will accept or permit one to redeem which coupons. Durable coupon token marketing module 134 can further distribute coupons, for example, as part of a paid marketing campaign by a participating company. Secure transaction initiation module 136 includes programming necessary to execute secure transactions required to transfer ownership of each of the durable coupon tokens from the company operating server 110 to purchasers providing purchase orders to server 110.

Storage device 140 can include an exemplary hard drive device and includes durable coupon token database 142 and marketing resource database 144. Durable coupon token database 142 includes files and information related to coupon tokens and associated digital security keys, for example, ensuring that duplicate security keys are not accidentally distributed. Marketing resource database 144 includes information necessary to operate a marketing campaign, for example, including advertising templates to enable details of the durable coupon tokens to published and contact lists for email campaigns.

The details of server 110 are provided as examples, and other processes and server details are envisioned based upon the particulars of the process operated by the coupon vendor. The examples provided are intended as non-limiting embodiments, and the disclosure is not intended to be limited to the examples provided.

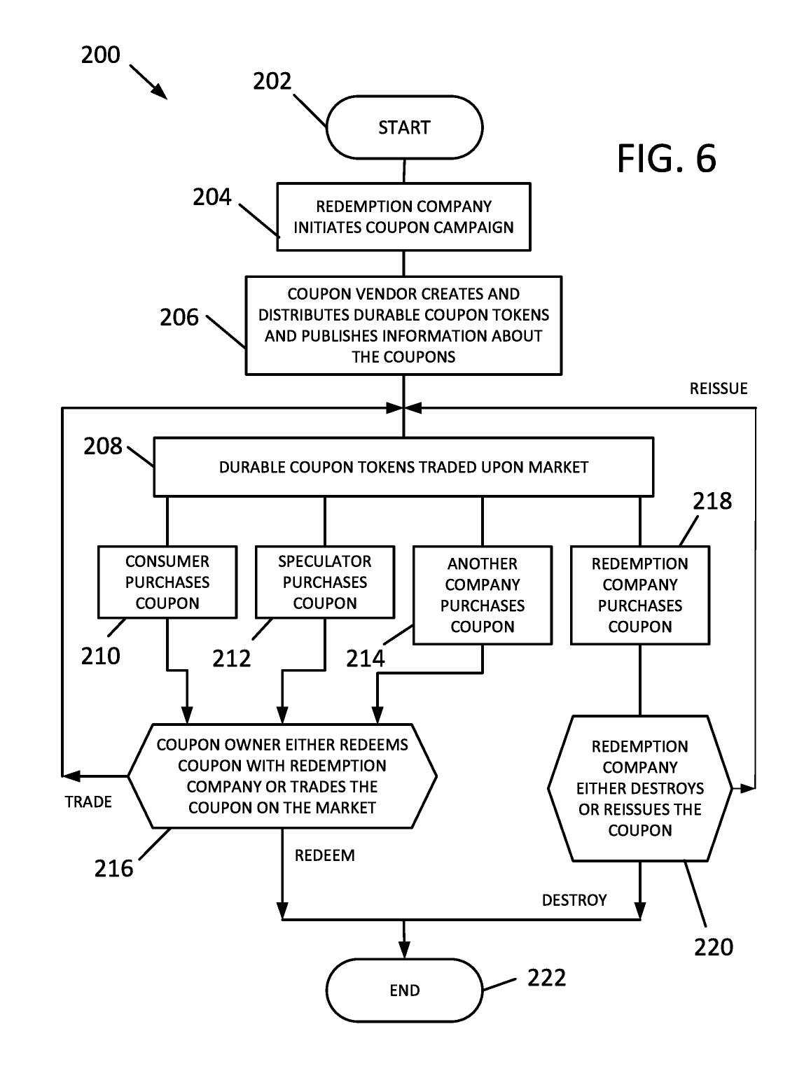

FIG. 6 illustrates an exemplary process flowchart for creating, distributing, trading, and redeeming durable coupon tokens including a particular redemption company and face value. Process 200 is illustrated and starts at step 202. At step 204, a redemption company seeking to increase publicity and sales for the goods or services of the redemption company initiates a coupon campaign with a coupon vendor. At step 206, the coupon vendor creates and distributes durable coupon tokens to a marketplace. At step 208, the durable coupons are traded upon the market.

Exemplary transactions within the marketplace are provided as process steps 210, 212, 214, and 218. It will be appreciated that a particular durable coupon token can take any of process steps 210, 212, 214, and 218, may cycle through the process steps repeatedly, or may stay in the possession of a single owner for any amount of time. In step 210, a consumer purchases a durable coupon token from the marketplace, and the process advances to step 216. In step 212, a speculator purchases a durable coupon token from the marketplace, and the process advances to step 216. In step 214, another company purchases a durable coupon token from the marketplace, and the process advances to step 216. At step 216, a coupon owner may either trade the durable coupon token upon the market by returning to step 208 or redeem the durable coupon token for face value with the redemption company, ending process 200 for that particular coupon token at step 222.

Step 218 is provided including the redemption company purchasing a durable coupon token from the market. The redemption company can then at step 220 reissue the coupon to the market, either directly or by making the coupon available through company internal advertising through return to step 208. In the alternative, the redemption company can destroy the coupon and the process ends for that coupon at step 222.

A number of alternatives to process 200 are envisioned. The process steps of process 200 are provided as examples, and the disclosure is not intended to be limited to the particular examples provided.

According to one embodiment of the disclosure, a computerized process to create and distribute a durable coupon token redeemable with a company agreeing to permit a user redeem the durable coupon token for a discount includes, within a computerized processor, operating programming configured to create the durable coupon token including a digital security key associated with the durable coupon token configured to provide transferrable ownership of the durable coupon token. Such a token can be used and traded between digital wallets according to the disclosure. The programming is further configured to publish the discount associated with the durable coupon token, for example, upon a website. The process further includes distributing the durable coupon token to a consumer. The durable coupon token is configured to enable the consumer to claim the discount with the company, for example, with the consumer electronically transferring ownership of the coupon to the company in return for the named discount. As will be appreciated, due to the durable nature of the coupon token, trading and redemption of the coupon can occur over and over again.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A computerized process to create and distribute a durable coupon token redeemable with a plurality of companies agreeing to permit a user to redeem the durable coupon token for value, comprising:
publicly listing the plurality of companies agreeing to permit the user to redeem the durable coupon token for value;
within a computerized processor, operating programming configured to:
create the durable coupon token comprising a digital security key associated with the durable coupon token;
distributing the durable coupon token to the user;
transferring ownership of the durable token from the user to one of the plurality of companies by recording the transferred ownership in a distributed ledger; and
subsequently repeatedly transferring ownership of the durable coupon token with the durable coupon token surviving each transfer.

2.-3. (canceled)

4. The process of claim 1, wherein the durable computer token is a generic durable computer token which is configured to be redeemed at any of the plurality of companies.

5. (canceled)

6. The process of claim 1, wherein creating the durable coupon token further comprises assigning a published face value specific to a particular redemption company.

7. The process of claim 6, wherein the published face value comprises a redemption benefit specific to the particular redemption company.

8. The process of claim 7, wherein the redemption benefit comprises early access to a new product.

9. The process of claim 7, wherein the redemption benefit comprises access to one of a concert, a cultural event, and a sporting event.

10. The process of claim 1, wherein distributing the durable coupon token comprises selling the durable coupon token on a website.

11. The process of claim 1, wherein distributing the durable coupon token comprises providing the durable coupon token on a website as part of an advertising campaign.

12. The process of claim 1, wherein distributing the durable coupon token comprises providing the durable coupon token for trading upon a third party market website.

13. The process of claim 1, wherein distributing the durable coupon token comprises mailing the durable coupon token to one consumer on a list of consumers.

14. A computerized process to create and distribute generic durable coupon tokens redeemable at a plurality of participating companies, comprising:
within a computerized processor, operating programming configured to:
create the durable coupon tokens comprising a digital security key associated with the durable coupon token configured to provide transferrable ownership of the durable coupon token;
digitally publish a list of the participating companies honoring the generic durable coupon tokens; and
distribute the durable coupons token to a plurality of consumers.

15. A computerized process to create and distribute a durable coupon token redeemable with a company agreeing to permit a user redeem the durable coupon token for a discount, comprising:
within a computerized processor, operating programming configured to:
create the durable coupon token comprising a digital security key associated with the durable coupon token configured to provide transferrable ownership of the durable coupon token; and
publish the discount associated with the durable coupon token; and
distributing the durable coupon token to a consumer;
wherein the durable coupon token is configured to enable the consumer to claim the discount with the company.
